(19) United States
(12) Patent Application Publication
(10) Pub. No.: US 2021/0105548 A1
(43) Pub. Date: Apr. 8, 2021

(54) METHOD AND DEVICE FOR COMMUNICATION IN PASSIVE OPTICAL NETWORK, AND COMPUTER-READABLE MEDIUM

(71) Applicant: NOKIA SOLUTIONS AND NETWORKS OY, Espoo (FI)

(72) Inventors: Chenhui Ye, Shanghai (CN); Dongxu Zhang, Shanghai (CN); Xiaofeng Hu, Shanghai (CN); Kaibin Zhang, Shanghai (CN)

(73) Assignee: Nokia Solutions and Networks Oy, Espoo (FI)

(21) Appl. No.: 16/975,934

(22) PCT Filed: Feb. 27, 2019
(86) PCT No.: PCT/CN2019/076348

§ 371 Date: Nov. 30, 2020

(30) Foreign Application Priority Data
Feb. 28, 2018 (CN) 201810166682.1

(51) Int. Cl. H04Q 11/00; H04B 10/291

(52) U.S. Cl. CPC H04Q 11/0067; H04Q 2011/0079; H04Q 11/0005; H04B 10/291

(57) ABSTRACT

Embodiments of the present disclosure relate to method, device and computer-readable medium for communication in a Passive Optical Network (PON). The method comprises receiving a first sequence from an Optical Network Unit (ONU) the first sequence being transmitted by using a reference sequence shared with the Optical Line Terminal (OLT) based on a first set of parameters associated with an uplink transmission from the ONU to the OLT; determining parameter adjustment information based on the first sequence and the reference sequence, the parameter adjustment information being used to adjust at least one parameter in the first set of parameters associated with the uplink transmission, to cause transmission property of the uplink to satisfy a predetermined condition; and transmitting the parameter adjustment information to the ONU.

### FIELD

Embodiments of the present disclosure relate to the field of optical communication, and more specifically, to method, device and computer-readable medium for communication in a Passive Optical Network (PONs).

### BACKGROUND

For PONs, higher capacity and lower cost are the persistent pursuits in both academic and industrial circles. The discussion and standardization on next-generation Ethernet passive optical networks (NG-EPONs) is a very typical example, where it is expected that a transmission capacity of 25 Gb/s can be realized by using legacy low-bandwidth and low-cost devices such as 10G transceivers. Meanwhile, a modest digital signal processor (DSP) such as an equalizer is becoming increasingly necessary for damage compensation. As a result, the cost-effectiveness advantage of using low-cost components is wasted by the additional cost of ONU using DSP (analog to digital converter (ADC)/digital to analog converter (DAC) are extra needed), in especially optical network units (ONUs).

Besides the evolution path towards NG-EPON, even higher speed such as 50 Gb/s per wavelength has also become an alternative in academia/industry for next generation PONs. For low cost purposes, reuse of low-bandwidth hardware remains the most important feature. Therefore, further more complex algorithms (e.g., recursive algorithms for likelihood estimation) must solve more severe problems caused by interactions between bandwidth restriction effect and nonlinear effects. The contradiction between low cost hardware and high complexity DSP becomes more prominent.

Furthermore, the other drawback on conventional solutions is that the unilateral equalization method lacks physical-layer global coordination between ONUs and optical line terminals (OLTs).

### SUMMARY

In general, the embodiments of the present disclosure provide a method and device for communication at an OLT and an ONU, as well as a computer-readable medium.

In a first aspect of the present disclosure, a method is provided for communication at an optical line terminal OLT. The method comprises receiving a first sequence from an ONU the first sequence being transmitted by using a reference sequence shared with the OLT based on a first set of parameters associated with an uplink transmission from the ONU to the OLT; determining parameter adjustment information based on the first sequence and the reference sequence, the parameter adjustment information being used to adjust at least one parameter in the first set of parameters associated with the uplink transmission, to cause transmission property of the uplink to satisfy a predetermined condition; and transmitting the parameter adjustment information to the ONU.

In a second aspect of the present disclosure, a method is provided for communication at an optical network unit ONU. The method comprises transmitting to an OLT, a reference sequence shared with the OLT based on a first set of parameters associated with an uplink transmission from the ONU to the OLT; and receiving parameter adjustment information from the OLT, the parameter adjustment information being determined by the OLT based on the reference sequence and a sequence received from the ONU, the parameter adjustment information being used to adjust at least one parameter in the first set of parameters, to cause transmission property of the uplink transmission to satisfy a predetermined condition.

In a third aspect of the present disclosure, an optical line terminal OLT is provided. The optical line terminal comprises: at least one processor; and a memory coupled to the at least one processor, the memory including instructions stored thereon, the instructions, when being executed by the at least one processor, cause the OLT to perform a method of the first aspect.

In a fourth aspect of the present disclosure, an optical network unit ONU is provided. The optical network unit comprises: at least one processor; and a memory coupled to the at least one processor, the memory including instructions stored thereon, the instructions, when being executed by the at least one processor, cause the OLT to perform a method of the second aspect.

In a fifth aspect, a computer-readable medium is provided. The computer-readable medium includes instructions stored thereon, the instructions, when executed by at least one processing unit, cause the at least one processing unit to be configured to perform a method of the first aspect.

In a sixth aspect, a computer-readable medium is provided. The computer-readable medium includes instructions stored thereon, the instructions, when executed by at least one processing unit, cause the at least one processing unit to be configured to perform a method of the second aspect.

It should be understood that what is described in the summary is neither intended to limit the key or essential features of exemplary embodiments of the present disclosure, nor to limit the scope of the present disclosure. Other features of the present disclosure will become apparent through the following description.

### BRIEF DESCRIPTION OF THE DRAWINGS

The foregoing and other features, benefits, and aspects of various embodiments of the present disclosure will become more apparent from the following detailed description with reference to the accompanying drawings, in which the same or similar reference signs are used to designate the same or similar elements, where:

FIG. 1 shows a schematic view of a communication system 100 in which the embodiments described in the present disclosure may be implemented;

FIG. 2 shows a schematic view of a process 200 for a communication method according to some example embodiments of the present disclosure;

FIG. 3 shows a schematic view of a process 300 for a communication method according to some example embodiments of the present disclosure;

FIG. 4 shows a flowchart of a method 400 for communication implemented at OLT according to some example embodiments of the present disclosure;

FIG. 5 shows a flowchart of a method 500 for communication implemented at ONU according to some example embodiments of the present disclosure;

FIGS. 6A and 6B show example experimental results according to some example embodiments of the present disclosure; and

FIG. 7 shows a simplified block diagram of an electronic device 700 which is suitable for implementing the some example embodiments of the present disclosure.

Throughout the drawings, the same or similar reference signs represent the same or similar elements.

### DETAILED DESCRIPTION OF EMBODIMENTS

Embodiments of the present disclosure will be described in more detail with reference to the accompanying drawings, wherein some embodiments are illustrated.

However, it should be understood that the present disclosure may be implemented in various ways and should not be construed as being limited to the embodiments illustrated herein. On the contrary, these embodiments are provided for a more thorough and complete understanding of the present disclosure. It should be understood that the drawings and embodiments of the present disclosure are only for the illustration purpose, rather than limiting the scope of the present disclosure.

As used herein, the terms “comprise”, “include” and variants thereof are intended to be inclusive, i.e. “including but not limited to”. The term “based on” is intended to include “based at least in part on”. The term “one embodiment” or “the embodiment” is intended to include “at least one embodiment”. The terms “first”, “second” and so on can refer to the same or different objects. The following description may also include other explicit and implicit definitions.

Currently, the digital signal processor (DSP) is becoming a very powerful and attractive tool for realizing additional transmission capacity by using legacy low-bandwidth optical device. At the same time, the complexity of DSP in the ONU, however, is dissipating up the cost efficiency. This is because such an ONU usually needs extra analog to digital converter (ADC)/digital to analog converter (DAC), and the superiority of cost efficiency by using low-cost components (e.g., legacy low-bandwidth optics) is getting dissipated up.

Furthermore, the link performance optimization of the conventional solution is merely based upon self-adjustment of the receiver but fails to consider the coordination between the receiver and the transmitter. Such adjustment is usually untargeted or causes the receiver to adjust parameters towards a wrong direction. Usually the adjustment result of such adjustment process usually is unsatisfied and also results in lower system efficiency.

Therefore, embodiments of the present disclosure provide a method for communication in a passive optical network. In the solution of the present disclosure, the OLT determines an adjustment mode of parameters used by ONU in uplink transmission, so that ONU can adjust parameters based on the adjustment mode and improves the transmission property of the uplink transmission. Therefore, a parameter adjustment process based on OLT-ONU coordination can be achieved. In this way, OLT can help ONU to adjust and optimize transmission parameters without introducing a complex processor or DSP into the ONU. As such, the system implementation cost can be effectively reduced while increasing the system efficiency.

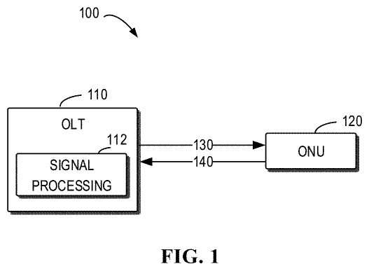

FIG. 1 shows a communication system 100 in which the embodiments of the present disclosure may be implemented. The communication system 100 comprises an OLT 110 and an ONU 120. As shown, the OLT 110 can communicate with the ONU 120. For example, data transmission can be performed via an uplink 130 from the ONU 120 to the OLT 110 and also via a downlink 140 from the OLT 110 to the ONU 120. It is to be understood that the number of ONUs shown in FIG. 1 is given for the purpose of illustration without suggesting any limitations. The communication network 100 may include any suitable number of ONUs.

As shown in FIG. 1, the OLT 110 comprises a signal processing device 112, which may be a DSP for example, especially a DSP based on artificial intelligence (AI). However, there is no signal processing device in the ONU 120 similar to that in the OLT 110. In the communication system 100 as described herein, the ONU 120 may share the signal processing device at the OLT 110. In a case where a plurality of ONUs 120 exist, all ONUs 120 may share the signal processing device at the OLT 110. By centralizing the signal processing device 112 at the OLT for implementation, the configuration of DSP in an entity of ONU is avoided, and further the system complexity is effectively reduced.

The optimization of the uplink 130 and the downlink 140 pointing to a specific target can be achieved through the coordination between the OLT 110 and the ONU 120. When the uplink optimization is performed for the purpose of maximizing the capacity of uplink 130, the ONU 120 transmits a reference sequence to the OLT 110 via the uplink 130 by using a predetermined set of parameters associated with the data the uplink transmission 130. The reference sequence may be known to both the OLT 110 and the ONU 120. With the signal processing device 120 (e.g., AI-based DSP) and based on a received training sequence associated with the reference sequence and the pre-known reference sequence, the OLT 110 may determine adjustment information used to adjust the set of parameters for the purpose of maximizing the capacity of the uplink 130 and transmit the information to the ONU 120, so that the ONU 120 can adjust one or more parameters in the set of parameters based on the adjustment information from the OLT 110. The optimization process may go through several cycles before finally achieving the capacity maximization of the uplink 130.

When the downlink optimization is performed for the purpose of maximizing the capacity of downlink 140, first the linearity of the uplink 130 needs to be maximized. The process of maximizing the linearity of the uplink 130 is essentially similar to the above method of maximizing the capacity of the uplink 130. The difference is only that the OLT 110, with the signal processing device 120 (e.g., AI-based DSP) and based on a received training sequence associated with the reference sequence and the pre-known reference sequence, may determine adjustment information used to adjust the set of parameters for the purpose of maximizing the linearity of the uplink 130 and transmit the information to the ONU 120 so as to achieve the capacity maximization of the uplink 130. Here, the purpose of maximizing the linearity of uplink 130 is to ensure that the transmission distortions can be minimized in the uplink transmission.

Since the linearity maximization of the uplink 130 has been achieved, which means that the predetermined set of parameters of the ONU 120 associated with the data the uplink transmission 130 has been determined. At this point, the downlink optimization for the purpose of maximizing the capacity of downlink 140 may be performed. Similarly, the OLT 110 transmits a reference sequence to the ONU 120 via the downlink 140 by using a predetermined set of parameters associated with the data the downlink transmission 140. At the ONU 120, no processing is performed to a received training sequence associated with the reference sequence, but the training sequence is transmitted to the OLT 110 via the uplink 130 that has achieved the linearity maximization. With the signal processing device 120 (e.g., AI-based DSP) and based on the received training sequence and the pre-known reference sequence, the OLT 110 may determine adjustment parameter information for its own set of parameters and adjust one or more parameters of the set of parameters according to the adjustment parameter information. The optimization process may go through several cycles before finally achieving the capacity maximization of the downlink 140.

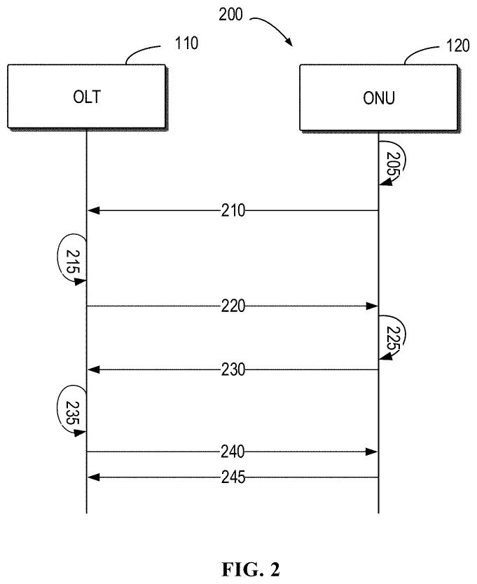

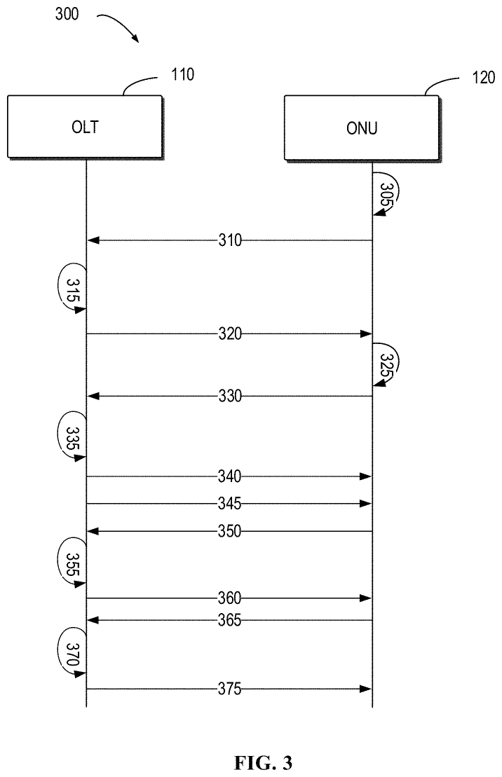

Further description is presented below to the process of a communication method In some example embodiments of the present disclosure in conjunction with FIGS. 2 and 3. FIG. 2 shows a schematic view of the process of the communication method according to some example embodiments of the present disclosure. FIG. 3 shows a schematic view of the process of the communication method according to some example embodiments of the present disclosure.

The embodiment shown in FIG. 2, for example, can be used for optimization for the purpose of maximizing the uplink capacity.

As shown in FIG. 2, the ONU 120 may determine whether the uplink from the ONU 120 to the OLT 110 has been optimized to a maximum capacity. If so, data may be directly transmitted 245 from the ONU 120 to the OLT 110. This process may be understood as a routine inquiry process when the system is started or restarted, or as an inquiry process performed by the system periodically, which may take place before 205 in FIG. 2. The process is not shown in FIG. 2 for the brevity purpose.

If the uplink has not been optimized to a maximum capacity, then the ONU 120 randomly assigns 205 a first set of parameters, the set of parameters can be associated with data the uplink transmission. The ONU 120 transmits 210 a reference sequence to the OLT 110 by using the first set of parameters. The reference sequence may be known to both the OLT 110 and the ONU 120. After receiving a training sequence associated with the reference sequence, the OLT determines parameter adjustment information used to adjust the first set of parameters based on the known reference sequence and the received training sequence. The parameter adjustment information indicates an adjustment mode for at least one parameter in the first set of parameters. The adjustment mode may comprise, for example, an adjustment direction and adjustment step for the at least one parameter.

After determining the parameter adjustment information, the OLT 110 transmits 220 the parameter adjustment information to the ONU 120. The ONU 120 adjusts 225 the first set of parameters based on the parameter adjustment information. Next, the ONU 120 transmits 230 the reference sequence to the OLT 110 by using the adjusted first set of parameters. The OLT 110 determines 235 whether the uplink has been optimized to the maximum capacity, based on the reference sequence and the training sequence associated with the reference sequence which is transmitted using the adjusted first set of parameters. If OLT 110 determines that the uplink has been optimized to the maximum capacity, an indication is transmitted 240 to the ONU to store the adjusted first set of parameters. After receiving the indication, the ONU 120 stores the adjusted first set of parameters and may transmit 245 data to the OLT 110. If OLT 110 determines that the uplink has not been optimized to the maximum capacity, then the steps 215 to 235 may be repetitively performed, till the uplink capacity maximization is achieved.

The embodiment shown in FIG. 3, for example, can be used for optimization for the purpose of maximizing the downlink capacity. As mentioned above, in order to satisfy the downlink capacity maximization, first the uplink linearity maximization needs to be satisfied. Because in the optimization process, the minimization of the transmission distortions should be achieved.

The ONU 120 may first determine whether the uplink from the ONU 120 to the OLT 110 has previously been optimized for the purpose of maximizing the linearity. If so, then the optimization for the purpose of maximizing the capacity of the downlink may directly start from 335. This process may take place before 305 in FIG. 3, which is not shown in FIG. 3 for the brevity purpose.

If the uplink has not optimized to maximum linearity, the ONU 120 then randomly assigns 305 a first set of parameters, the set of parameters can be associated with data the uplink transmission. The ONU 120 transmits 210 a reference sequence to the OLT 110 by using the first set of parameters. The reference sequence may be known to both the OLT 110 and the ONU 120. After receiving a training sequence associated with the reference sequence, the OLT determines 315 parameter adjustment information used to adjust the first set of parameters based on the known reference sequence and the received training sequence. The parameter adjustment information indicates an adjustment mode for at least one parameter in the first set of parameters. The adjustment mode may comprise, for example, an adjustment direction and adjustment step for the at least one parameter.

After determining the parameter adjustment information, the OLT 110 transmits 320 the parameter adjustment information to the ONU 120. The ONU 120 adjusts 325 the first set of parameters based on the parameter adjustment information. Next, the ONU 120 transmits 330 the reference sequence to the OLT 110 by using the adjusted first set of parameters. The OLT 110 determines whether the uplink has been optimized to the maximum capacity, based on the reference sequence and the training sequence associated with the reference sequence which is transmitted using the adjusted first set of parameters. Here assume that the OLT 110 determines that the uplink has been optimized to the maximum linearity. Thereby, the optimization for the purpose of maximizing the capacity of the downlink can start.

The OLT 110 randomly assigns 335 a second set of parameters, the set of parameters being associated with data the downlink transmission. The OLT 110 transmits 340 the reference sequence to the ONU 120 by using the second set of parameters. The ONU 120 does not perform any processing to a received training sequence associated with the reference sequence (because no DSP is configured at the ONU 120). The ONU 120 simply transmits 350 the received training sequence to the OLT 110 by using the adjusted first set of parameters obtained in previous steps. Since the uplink from the ONU 120 to the OLT 110 has satisfied maximum linearity, there should be no distortion in the training sequence from ONU 120 to OLT 110 in theory. Then, the OLT 110 can determine parameter adjustment information used to adjust the second set of parameters based on the received training sequence and reference sequence. The parameter adjustment information indicates an adjustment mode for at least one parameter in the second set of parameters, so that the second set of parameters can be modulated for the purpose of maximizing the capacity of the downlink.

After adjusting the at least one parameter in the second set of parameters based on the parameter adjustment information, the OLT 110 transmits 360 the reference sequence to the ONU 120 by using the adjusted second set of parameters. Likewise, the ONU 120 transmits 365 the received training sequence to the OLT 110 by using the adjusted first set of parameters obtained in previous steps. Based on the reference sequence and the received training sequence, the OLT 110 determines 370 whether the downlink from the OLT 110 from the ONU 120 has satisfied capacity maximization after the second set of parameters is adjusted. If the OLT 110 determines that the downlink has been optimized to the the maximum capacity, then the adjusted second set of parameters is stored, and data may be transmitted 375 via the downlink from the OLT 110 to the ONU 120.

If the OLT 110 determines that the downlink has not been optimized to the maximum capacity, then the steps 335 to 370 may be repetitively performed, till the downlink capacity maximization is achieved.

In this way, according to the embodiments of the present disclosure, the functionality of DSP is merely centralized on the OLT side, so that ONU can share DSP of OLT. Therefore, the complexity of the OLT side is significantly reduced. In addition, by using an AI-based DSP in place of a traditional algorithm to obtain a training model for training uplink and downlink, the computation precision can be significantly increased so as to obtain links satisfying some desired channel characteristics. Moreover, by performing parameter adjustment under the goal of some channel characteristics through the coordination between OLT and ONU, a targeted and directional parameter adjustment process can be achieved, so that the adjustment is simplified to obtain ideal adjustment results and link characteristics.

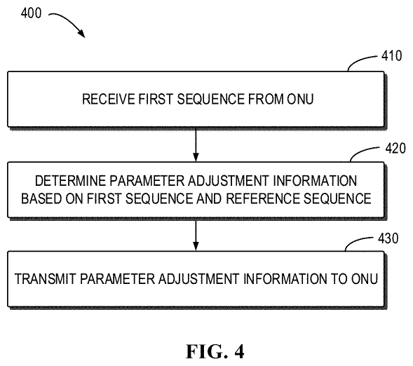

FIG. 4 shows a flowchart of a method 400 for communication implemented at OLT according to embodiments of the present disclosure. Now further description is presented to the communication method at OLT with reference to FIG. 4. It may be understood that the embodiment described in FIG. 4 may be implemented at the OLT 110 as shown in FIG. 1.

At block 410, a first sequence is received from the optical network unit ONU 120, the first sequence being transmitted using a reference sequence shared with the OLT 110 based on a first set of parameters associated with an uplink transmission from the ONU 120 to the OLT 110. In some embodiments, the reference sequence may be understood as being predetermined and known to both the ONU 120 and the OLT 110. The first sequence may be understood as the reference sequence which has changed when being transmitted to the OLT 110 via the uplink from the ONU 120 to the OLT 110.

At block 420, parameter adjustment information is determined based on the first sequence and the reference sequence, the parameter adjustment information being used to adjust at least one parameter in the first set of parameters associated with the uplink transmission so that transmission property of the uplink satisfy a predetermined condition.

As mentioned above, the first sequence may be understood as the reference sequence which has changed when being transmitted to the OLT 110 via the uplink from the ONU 120 to the OLT 110. In conjunction with the schematic view of the OLT 110 shown in FIG. 1, the OLT 110 can determine the uplink from the ONU 120 to the OLT 110 based on the reference sequence and the first sequence by using the signal processing device 120,

In some example embodiments, determining the parameter adjustment information may comprise determining a difference between the first sequence and the reference sequence. If the difference exceeds a threshold difference, at least one of an adjustment direction and an adjustment amplitude of the at least one parameter of the first set of parameters is determined. This may be implemented using an appropriate algorithm, e.g., Maximum Likelihood Estimation.

In some example embodiments, determining parameter adjustment information may comprise obtaining a parameter adjustment model, inputting the first sequence and the reference sequence to the parameter adjustment model, and determining at least one of an adjustment direction and an adjustment amplitude based on an output of the parameter adjustment model. This may be implemented by, for example, the AI-based DSP at the OLT 110.

The parameter adjustment model may be understood as a learning network. As used herein, the term “learning network” refers to such a model that can learn the association between corresponding input and output from training data and thereby after completion of the training, process a given input based on a set of parameters obtained from the training to generate a corresponding output. The “learning network” sometimes may also be called “neural network,” “learning model,” “network” or “model.” These terms may be interchangeably used herein.

The parameter adjustment model may be generated based on a historical received sequence and a reference sequence associated with the historical received sequence. In this way, with the parameter adjustment model, only the first sequence and the reference sequence need to be input to the model as input information, and then an indication of at least one of the adjustment direction and the adjustment amplitude of the at least one parameter of the first set of parameters can be obtained as an output.

As compared with traditional algorithms (e.g., Maximum Likelihood Estimation), neural network (AI-NN) based equalization DSP is lower in complexity. Furthermore, AI-based DSP can achieve significantly improved channel compensation effect than general linear equalization algorithms.

In the embodiments of the present disclosure, transmission properties may refer to various characteristics associated with uplink and/or downlink transmission, such as linearity, channel capacity, channel quality, channel loss, transmission distance, etc. However, transmission properties are not limited to the above enumerated examples. All transmission properties within the scope of the present disclosure may be included.

In some embodiments, the at least one parameter may be a bias current, a driving amplitude, an optical transmitting power and a baud rate, a modulation format and/or other other appropriate transmission-related parameters (also abbreviated as “transmission parameters” in the context of the present disclosure). The above examples about parameters are merely illustrative and not limiting.

At block 430, the OLT 110 transmits the parameter adjustment information to the ONU 120.

In some example embodiments, for the propose of maximizing the uplink capacity, determining the parameter adjustment information may comprise determining first parameter adjustment information used to adjust at least one parameter in the first set of parameters. The OLT 110 transmits the first parameter adjustment information to the ONU 120, so that the ONU 120 can adjust one or more parameters in the first set of parameters based on the first parameter adjustment information and further the uplink capacity satisfies a first predetermined condition.

In some example embodiments, for the propose of maximizing the uplink linearity, determining the parameter adjustment information may further comprise determining first parameter adjustment information used to adjust at least one parameter in the first set of parameters. The OLT 110 transmits the first parameter adjustment information to the ONU 120, so that the ONU 120 can adjust one or more parameters in the first set of parameters based on the first parameter adjustment information and further the uplink capacity satisfies a second predetermined condition.

As mentioned above, for the purpose of maximizing the uplink linearity is to train the downlink by the uplink with minimized distortion. Therefore, in some example embodiments, after the uplink linearity is made to satisfy the second predetermined condition, the OLT 110 may transmit the reference sequence to the ONU 120 and receive a second sequence from the ONU 120, the second sequence being a sequence which is transmitted by the ONU based on a first set of parameters adjusted using the parameter adjustment information, the sequence being the reference sequence received from the ONU 120.

Next, second parameter adjustment information used to adjust a second set of parameters associated with transmission of a downlink from the OLT 110 from the ONU 120 can be determined based on the second sequence and the reference sequence. For the purpose of maximizing downlink capacity, the second adjustment information can make the downlink capacity satisfy a third predetermined condition.

In some example embodiments, after determining the second adjustment information, the OLT 110 uses the second adjustment information to adjust the second set of parameters.

In this way, the optimized coordination between OLT and ONU is achieved. Such optimized coordination can perform parameter adjustment under the goal of some channel characteristics, the parameter adjustment process can be effected in a targeted and directional way, the adjustment process is simplified, the system efficiency is improved, and further ideal adjustment results and link characteristics are obtained.

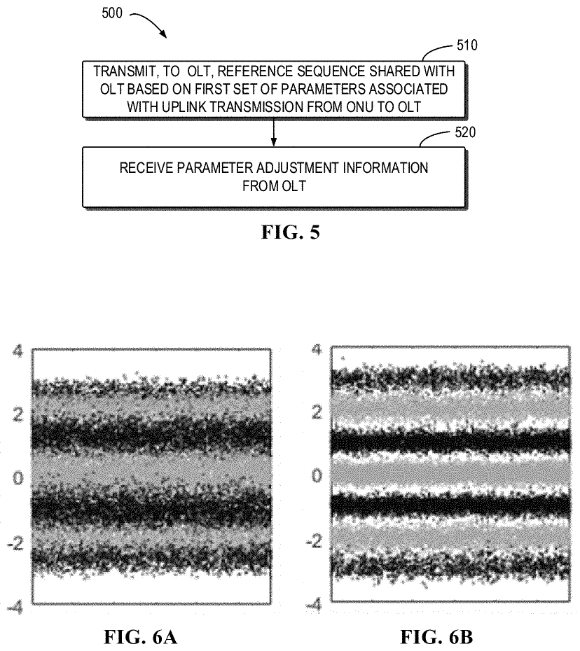

FIG. 5 shows a flowchart of a method 500 for communication implemented at ONU according to embodiments of the present disclosure. Further description is presented below to the communication method implemented at ONU. It may be understood that the embodiment described in FIG. 5 may be implemented at the ONU 120 as shown in FIG. 1.

At block 510, the ONU 120 transmits to the OLT 110 a reference sequence shared with the OLT based on a first set of parameters associated with an uplink from the ONU 120 to the OLT 110.

At block 520, the ONU 120 receives parameter adjustment information from the OLT 110, the parameter adjustment information (i.e., the first parameter adjustment information mentioned while describing FIG. 4) being determined by the OLT 110 based on the reference sequence and a sequence received from the ONU, the parameter adjustment information being used to adjust at least one parameter in the first set of parameters so that transmission property of the uplink satisfy a predetermined condition.

In some example embodiments, the ONU 120 can adjust the at least one parameter in the first set of parameters according to the parameter adjustment information. For the purpose of maximizing the uplink capacity, the parameter adjustment information can cause the first set of parameters to be optimized to the purpose of maximizing the uplink capacity. Specifically, the parameter adjustment information may indicate an adjustment direction and/or adjustment step of the at least one parameter in the first set of parameters. Similarly, for the purpose of maximizing the uplink linearity, the parameter adjustment information can cause the first set of parameters to be optimized to the purpose of maximizing the uplink linearity. Specifically, the parameter adjustment information may indicate an adjustment direction and/or adjustment step of the at least one parameter in the first set of parameters.

In some example embodiments where the maximum uplink linearity has been achieved, the ONU 120 can receive the reference sequence from the OLT 110 and transmit a second sequence to the OLT 110 by using the first set of parameters adjusted based on the parameter adjustment information, so that the OLT 110 may determine further parameter adjustment information (i.e., the second parameter adjustment information mentioned while describing FIG. 4) of a second set of parameters associated with transmission of a downlink from the OLT to the ONU based on the second sequence and the reference sequence, and capacity of the downlink is caused to satisfy a third predetermined condition.

In some example embodiments, the at least one parameter may include at least one of bias current, driving amplitude, optical transmitting power, baud rate and modulation format. Other parameters can also be considered without departing from the scope of the present disclosure.

FIGS. 6A and 6B show example experimental results according to some example embodiments of the present disclosure. In experiments, 20 Gb/s uplink transmission and 18.75 Gb/s downlink transmission are adjusted using an off-the-shelf 2.5G DML and based on artificial intelligence-neural network (AI-NN) adaptive equalization.

According to experimental results, downlink capacity can reach up to 18.75-Gb/s [in the format of PAM8], and uplink capacity can reach up to 20 Gb/s [in the format of duobinary-PAM4].

The benefit of AI-DSP-centralization for uplink can be obviously seen from the comparison between FIGS. 6A and 6B. In FIG. 6A, 7 amplitude levels (severe ISI of 4 level amplitude representing 00, 01, 10, 11) can hardly be identified because of overlaps between each other without AI-DSP in OLT. In FIG. 6B, each amplitude can be clearly identified after using AI-DSP based treatment.

The foregoing benefit is also proved in experiments to have significant effect on downlink optimization. On the other hand, experiments also have proved that a lower bit error rate (BER) can be obtained in uplink and downlink optimization based on OLT-ONU coordination.

To sum up, on the one hand, the embodiments of the present disclosure make it possible that the functionality of DSP is only centralized on the OLT side, so that ONU can share DSP at OLT and further the ONU complexity is significantly reduced. In addition, by using an AI-based DSP in place of a traditional algorithm to obtain a training model for training uplink and downlink, the computation precision can be significantly increased so as to obtain links satisfying some desired channel characteristics. Moreover, by performing parameter adjustment under the goal of some channel characteristics through the coordination between OLT and ONU, a targeted and directional parameter adjustment process can be achieved, so that the adjustment is simplified to obtain ideal adjustment results and link characteristics.

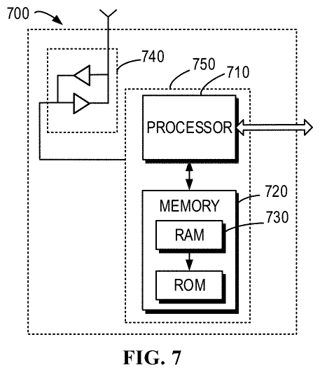

FIG. 7 is a simplified block diagram of a device 700 that is suitable for implementing the embodiments of the present disclosure. The device 700 may be provided to implement a communication device, such as the OLT 110 and the ONU 120 shown in FIG. 1. As depicted, the device 700 includes one or more processors 710, one or more memories 720 coupled to the processor(s) 710, and one or more transmitters and/or receivers (TX/RX) 740 coupled to the processor 710.

The processor 710 may be of any type suitable to the local technical environment, and may include one or more of the following: general-purpose computers, special-purpose computers, microprocessors, digital signal controllers (DSPs), and processors based multicore processor architecture. The device 700 may include multiple processors, such as an application specific integrated circuit chip that is slaved in time to a clock which synchronizes the main processor.

The memory 720 may be of any type suitable to the local technical environment and may be implemented using any appropriate data storage technique, as non-limiting examples, such as a non-transistory computer-readable storage medium, a semiconductor-based storage device, a magnetic memory device and system, an optical memory device and system, an unremovable memory and a removable memory.

The memory 720 stores at least one part of a program 730. The TX/RX 740 is used for two-way communication. The TX/RX 740 has at least one antenna for facilitating communication. The communication interface may represent any interface necessary for communication with other device.

Suppose the program 730 includes program instructions, which, when executed by the associated processor 710, cause the device 700 to perform implementations of the present disclosure as discussed with reference to FIGS. 2 to 5. That is, the implementations of the present disclosure may be effected by computer software executable to the processor 710 of the device 700 or by a combination of software and hardware.

Generally, various example implementations of the present disclosure may be implemented in hardware or special purpose circuits, software, logic, or any combination thereof. Some aspects may be implemented in hardware, while other aspects may be implemented in firmware or software that may be executed by a controller, microprocessor, or other computing device. While various aspects of embodiments of the present disclosure are illustrated and described as block diagrams, flowcharts, or using some other pictorial representations, it is to be understood that the blocks, devices, systems, techniques, or methods described herein may be implemented in, as non-limiting examples, hardware, software, firmware, special-purpose circuits or logic, general purpose hardware or a controller or other computing devices, or some combination thereof.

As one example, the implementations of the present disclosure may be described in the context of computer-executable instructions, such as those included in program modules, which are executed in a device on a target real or virtual processor. Generally speaking, the program modules include a routine, a program, a library, an object, a class, a component, a data structure, etc., which perform a particular task or implement a particular abstract data structure. In various exemplary embodiments, functions of the program modules may be merged or divided between the described program modules. Machine-executable instructions for program modules can be executed locally or in distributed devices. In distributed devices, the program modules may be located in both a local storage medium and a remote storage medium.

Computer program codes for implementing the method of the present disclosure may be written in one or more programming languages. These computer program codes may be provided to a processor of a general-purpose computer, a special-purpose computer, or other programmable data processing apparatus, so that the program codes, when executed by the computer or other programmable data processing apparatus, cause the functions/operations specified in the flowchart and/or block diagram to be implemented. The program codes may execute entirely on a computer, partly on a computer, as an independent software package, partly on a computer and partly on a remote computer, or entirely on a remote computer or server.

In the context of the present disclosure, the computer program codes or related data may be carried by any suitable carrier to cause a device, an apparatus, or a processor to perform various processes and operations as described above. Examples of carriers include a signal, a computer-readable medium, and the like. Examples of the signal may include an electrical signal, an optical signal, radio, sound, or propagated signals in other forms, such as a carrier wave, an infrared signal, and the like. The computer-readable medium may be a computer-readable signal medium or a computer-readable storage medium. The computer-readable medium may include, but is not limited to, electronic, magnetic, optical, electromagnetic, infrared, or semiconductor systems, apparatuses or devices, or any suitable combination thereof. More detailed examples of the computer-readable storage medium include an electrical connection with one or multiple wires, a portable computer magnetic disk, a hard disk, a random access memory (RAM), a read-only memory (ROM), an erasable programmable ROM (EPROM or flash memory), an optical storage device, a magnetic storage device, or any suitable combination thereof.

In addition, although the operations are depicted in a particular order, this should not be construed as requiring or suggesting that such operations are required to be performed in the particular order or that all illustrated operations are required to be performed to achieve desirable results. On the contrary, the steps depicted in the flowchart may be performed in a different order. Additionally or alternatively, some steps may be omitted, a plurality of steps may be combined into one step, and/or one step may be decomposed into a plurality of steps. Further, it should be noted that features and functions of two or more apparatuses of the present disclosure may be embodied in one apparatus, and vice versa, features and functions of one apparatus may further be embodied in a plurality of apparatuses.

Although the present disclosure has been described with reference to several embodiments, it should be understood that the present disclosure is not limited to the specific embodiments disclosed herein. The present disclosure is intended to cover various modifications and equivalent arrangements included within the spirit and scope of the claims as appended.

1. A method for communication at an Optical Line Terminal, OLT, comprising:
receiving a first sequence from an Optical Network Unit, ONU, the first sequence being transmitted by using a reference sequence shared with the OLT based on a first set of parameters associated with an uplink transmission from the ONU to the OLT;
determining parameter adjustment information based on the first sequence and the reference sequence, the parameter adjustment information being used to adjust at least one parameter in the first set of parameters associated with the uplink transmission, to cause transmission property of the uplink to satisfy a predetermined condition; and
transmitting the parameter adjustment information to the ONU.

2. The method of claim 1, wherein determining the parameter adjustment information comprises:
determining a difference between the first sequence and the reference sequence;
in accordance with a determination that the difference exceeds a threshold difference, determining at least one of the at least one parameter:
an adjustment direction; and
an adjustment amplitude.

3. The method of claim 1, wherein determining the parameter adjustment information comprises:
obtaining a parameter adjustment model;
inputting the first sequence and the reference sequence to the parameter adjustment model; and
determining, based on an output of the parameter adjustment model, at least one of the at least one parameter:
an adjustment direction; and
an adjustment amplitude.

4. The method of claim 3, wherein the parameter adjustment model is generated based on a historical received sequence and a reference sequence associated with the historical received sequence.

5. The method of claim 1, wherein determining the parameter adjustment information comprises:
determining the parameter adjustment information used to adjust the at least one parameter in the first set of parameters, to cause a capacity of the uplink to satisfy a first predetermined condition.

6. The method of claim 1, wherein determining the parameter adjustment information comprises:
determining the parameter adjustment information used to adjust the at least one parameter in the first set of parameters, to cause a linearity of the uplink to satisfy a second predetermined condition.

7. The method of claim 6, further comprising:
in accordance with a determination that the linearity of the uplink satisfies the second predetermined condition, transmitting the reference sequence to the ONU;
receiving a second sequence from the ONU, the second sequence being a sequence transmitted based on an adjusted first set of parameters adjusted by the parameter adjustment information, the sequence being the reference sequence received from the ONU; and
determining, based on the second sequence and the reference sequence, further parameter adjustment information used to adjust a second set of parameters associated with a downlink transmission from the OLT to the ONU, to cause a capacity of the downlink to satisfy a third predetermined condition.

8. The method of claim 7, further comprising:
adjusting the second set of parameters by the further parameter adjustment information.

9. The method of claim 1, wherein the at least one parameter comprises at least one of:
a bias current;
a driving amplitude;
an optical transmitting power;
a baud rate; and
a modulation format.

10. A method for communication at an Optical Network Unit, ONU, comprising:
transmitting to an Optical Line Terminal, OLT, a reference sequence shared with the OLT based on a first set of parameters associated with an uplink transmission from the ONU to the OLT; and
receiving parameter adjustment information from the OLT, the parameter adjustment information being determined by the OLT based on the reference sequence and a sequence received from the ONU, the parameter adjustment information being used to adjust at least one parameter in the first set of parameters, to cause transmission property of the uplink transmission to satisfy a predetermined condition.

11. The method of claim 10, further comprising:
in response to receiving a reference sequence transmitted from the OLT, transmitting, to the OLT, a second sequence based on an adjusted first set of parameters adjusted by the parameter adjustment information, such that the OLT determines, based on the second sequence and the reference sequence, further parameter adjustment information used to adjust a second set of parameters associated with a downlink transmission from the OLT to the ONU, to cause a capacity of the downlink transmission to satisfy a third predetermined condition.

12. The method of claim 10, wherein the at least one parameter is at least one of:
a bias current;
a driving amplitude;
an optical transmitting power;
a baud rate; and
a modulation format.

13. An optical line terminal OLT, comprising:
at least one processor; and
a memory coupled to the at least one processor, the memory including instructions stored thereon, the instructions, when being executed by the at least one processor, cause the OLT to perform a method of claim 1.

14. An optical network unit ONU, comprising:
at least one processor; and
a memory coupled to the at least one processor, the memory including instructions stored thereon, the instructions, when being executed by the at least one processor, cause the OLT to perform a method of claim 10.

15. A computer-readable medium, including instructions stored thereon, the instructions, when executed by at least one processing unit, cause the at least one processing unit to be configured to perform a method of claim 1.

16. A computer-readable medium, including instructions stored thereon, the instructions, when executed by at least one processing unit, cause the at least one processing unit to be configured to perform a method of claim 10.
